(19) United States
(12) Patent Application Publication
(10) Pub. No.: US 2014/0207514 A1
(43) Pub. Date: Jul. 24, 2014

(54) INSPECTION DATA PROVISION

(71) Applicant: GENERAL ELECTRIC COMPANY, Schenectady, NY (US)

(72) Inventors: Michael Christopher Domke, Skaneateles, NY (US); Sekhar Soorianarayanan, Bangalore (IN); Thomas Eldred Lambdin, Auburn, NY (US); Robert Carroll Ward, Essex, CT (US); Scott Leo Sbihli, Lexington, MA (US)

(73) Assignee: GENERAL ELECTRIC COMPANY, Schenectady, NY (US)

(21) Appl. No.: 13/747,416

(22) Filed: Jan. 22, 2013

(51) Int. Cl. G06Q 10/06

(52) U.S. Cl. CPC G06Q 10/06316
USPC 705/7.26

(57) ABSTRACT

A method provides identification information configured to identify a particular step or portion of an inspection process. Supplemental data relating to the particular step or portion is received based at least in part upon the identification information. This supplemental data is presented to an inspector or other operator.

### BACKGROUND

The subject matter disclosed herein relates to inspection planning, execution, and reporting. More specifically, the subject matter disclosed herein relates to providing reference materials during an inspection, which may facilitate the inspection.

Certain equipment and facilities, such as power generation equipment and facilities, oil and gas equipment and facilities, aircraft equipment and facilities, manufacturing equipment and facilities, and the like, include a plurality of interrelated systems, and processes. For example, power generation plants may include turbine systems and processes for operating and maintaining the turbine systems. Likewise, oil and gas operations may include carbonaceous fuel retrieval systems and processing equipment interconnected via pipelines. Similarly, aircraft systems may include airplanes and maintenance hangars useful in maintaining airworthiness and providing for maintenance support. During equipment operations, the equipment may degrade, encounter undesired conditions such as corrosion, wear and tear, and so on, potentially affecting overall equipment effectiveness. Certain inspection techniques, such as non-destructive inspection techniques or non-destructive testing (NDT) techniques, may be used to detect undesired equipment conditions.

In a conventional NDT system, data may be shared with other NDT operators or personnel using portable memory devices, paper, of through the telephone. As such, the amount of time to share data between NDT personnel may depend largely on the speed at which the physical portable memory device is physically dispatched to its target. Accordingly, it would be beneficial to improve the data sharing capabilities of the NDT system, for example, to more efficiently test and inspect a variety of systems and equipment. NDT relates to the examination of an object, material, or system without reducing future usefulness. In particular NDT inspections may be used to determine the integrity of a product using time-sensitive inspection data relating to a particular product. For example, NDT inspections may observe the “wear and tear” of a product over a particular time-period.

Many forms of NDT are currently known. For example, perhaps the most common NDT method is visual examination. During a visual examination, an inspector may, for example, simply visually inspect an object for visible imperfections. Alternatively, visual inspections may be conducted using optical technologies such as a computer-guided camera, a borescope, etc. Radiography is another form of NDT. Radiography relates to using radiation (e.g., x-rays and/or gamma rays) to detect thickness and/or density changes to a product, which may denote a defect in the product. Further, ultrasonic testing relates to transmitting high-frequency sound waves into a product to detect changes and/or imperfections to the product. Using a pulse-echo technique, sound it introduced into the product and echoes from the imperfections are returned to a receiver, signaling that the imperfection exists. Many other forms of NDT exist. For example, magnetic particle testing, penetrant testing, electromagnetic testing, leak testing, and acoustic emission testing, to name a few.

Oftentimes, product inspections may be quite complex due to the complex nature of the product being tested. For example, airplanes are very complex machines where safety and inspection standards are of the utmost importance. The Boeing 777 aircraft may have as many 3 million parts. Accordingly, a tremendous amount of time and effort is used to inspect these aircraft on a periodic basis. Further, historical data relating to previous inspections may be used to compare and contrast inspection results to understand trending data. Further, inspection data for an entire fleet of products (e.g., a fleet of Boeing 777's) may be useful for inspection purposes, as may reference materials provided by a manufacturer or other source. As may be appreciated, massive amounts of data may be gathered and used in the inspection process. This data may be pulled from many sources and may be crucial for accurate inspection.

Unfortunately, in conventional inspection systems, accessing this data is predominantly a manual process. This manual process may lead to inefficient use of inspection personnel and equipment. Accordingly, improved systems and methods for filtering and/or accessing inspection data are desirable.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a method is provided. The method includes providing, via a computer processor, identification information configured to identify a particular step or portion of an inspection process; receiving supplemental data relating to the particular step or portion based at least in part upon the identification information; and presenting the supplemental data.

In a second embodiment, an inspection equipment is provided. The inspection equipment includes step determination logic that determines a particular step or portion of an inspection process that the inspection equipment is being used to execute; communications circuitry that queries a data provider for supplemental data relating at least to the particular step or portion and receive the supplemental data from the data provider; and at least one presentation device that presents the supplemental data.

In a third embodiment, a system is provided. The system includes a data provider that receives a request for supplemental data relating to a particular step or portion of an inspection process; gathers the supplemental data from one or more data sources; and provides the gathered supplemental data to a requestor of the supplemental data.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram illustrating an embodiment of a distributed non-destructive testing (NDT) system, including a mobile device;

FIG. 2 is a block diagram illustrating further details of an embodiment of the distributed NDT system of FIG. 1;

FIG. 3 is a front view illustrating an embodiment of a borescope system 14 communicatively coupled to the mobile device of FIG. 1 and a “cloud;”

FIG. 4 is an illustration of an embodiment of a pan-tilt-zoom (PTZ) camera system communicatively coupled to the mobile device of FIG. 1;

FIG. 5 is a flowchart illustrating an embodiment of a process useful in using the distributed NDT system for planning, inspecting, analyzing, reporting, and sharing of data, such as inspection data;

FIG. 6 is a block diagram of an embodiment of information flow through a wireless conduit;

FIG. 7 is a flowchart illustrating a process for providing reference information during an inspection, in accordance with an embodiment;

FIG. 8 is a schematic diagram of an inspection system useful for providing reference information during an inspection, in accordance with an embodiment;

FIG. 9 is a schematic diagram of an alternate inspection system useful for providing reference information during an inspection, in accordance with an embodiment; and

FIG. 10A and FIG. 10B collectively illustrate a schematic view of a progression of presenting step-specific supplemental data, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure may apply to a variety of inspection and testing techniques, including non-destructive testing (NDT) or inspection systems. In the NDT system, certain techniques such as borescopic inspection, weld inspection, remote visual inspections, x-ray inspection, ultrasonic inspection, eddy current inspection, and the like, may be used to analyze and detect a variety of conditions, including but not limited to corrosion, equipment wear and tear, cracking, leaks, and so on. The techniques described herein provide for improved NDT systems suitable for borescopic inspection, remote visual inspections, x-ray inspection, ultrasonic inspection, and/or eddy current inspection, enabling enhanced data gathering, data analysis, inspection/testing processes, and NDT collaboration techniques.

The improved NDT systems described herein may include inspection equipment using wireless conduits suitable for communicatively coupling the inspection equipment to mobile devices, such as tablets, smart phones, and augmented reality eyeglasses; to computing devices, such as notebooks, laptops, workstations, personal computers; and to “cloud” computing systems, such as cloud-based NDT ecosystems, cloud analytics, cloud-based collaboration and workflow systems, distributed computing systems, expert systems and/or knowledge-based systems. Indeed, the techniques described herein may provide for enhanced NDT data gathering, analysis, and data distribution, thus improving the detection of undesired conditions, enhancing maintenance activities, and increasing returns on investment (ROI) of facilities and equipment.

In one embodiment, a tablet may be communicatively coupled to the NDT inspection device (e.g., borescope, transportable pan-tilt-zoom camera, eddy current device, x-ray inspection device, ultrasonic inspection device), such as a MENTOR™ NDT inspection device, available from General Electric, Co., of Schenectady, N.Y., and used to provide, for example, enhanced wireless display capabilities, remote control, data analytics and/or data communications to the NDT inspection device. While other mobile devices may be used, the use of the tablet is apt, however, insofar as the tablet may provide for a larger, higher resolution display, more powerful processing cores, an increased memory, and improved battery life. Accordingly, the tablet may address certain issues, such as providing for improved visualization of data, improving the manipulatory control of the inspection device, and extending collaborative sharing to a plurality of external systems and entities.

Keeping the foregoing in mind, the present disclosure is directed towards sharing data acquired from the NDT system and/or control of applications and/or devices in the NDT system. Generally, data generated from the NDT system may be automatically distributed to various people or groups of people using techniques disclosed herein. Moreover, content displayed by an application used to monitor and/or control devices in the NDT system may be shared between individuals to create a virtual collaborative environment for monitoring and controlling the devices in the NDT system.

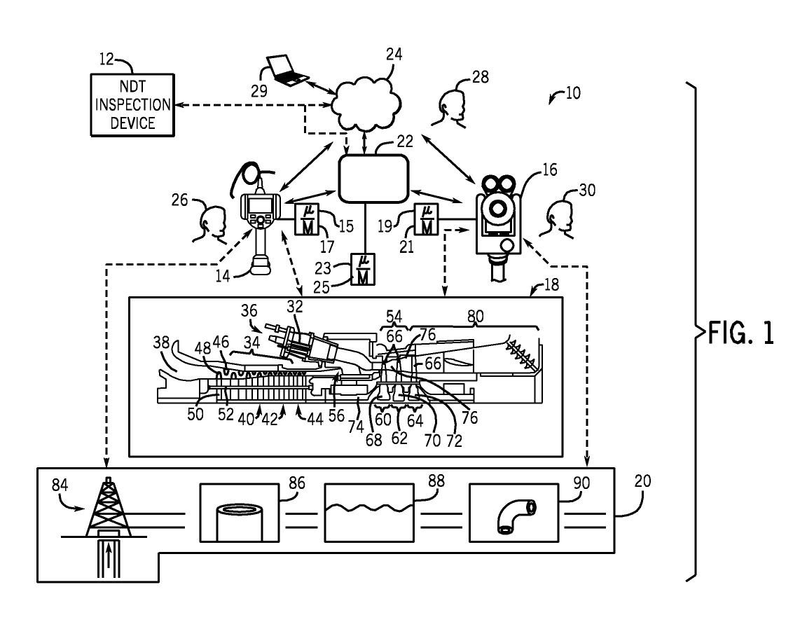

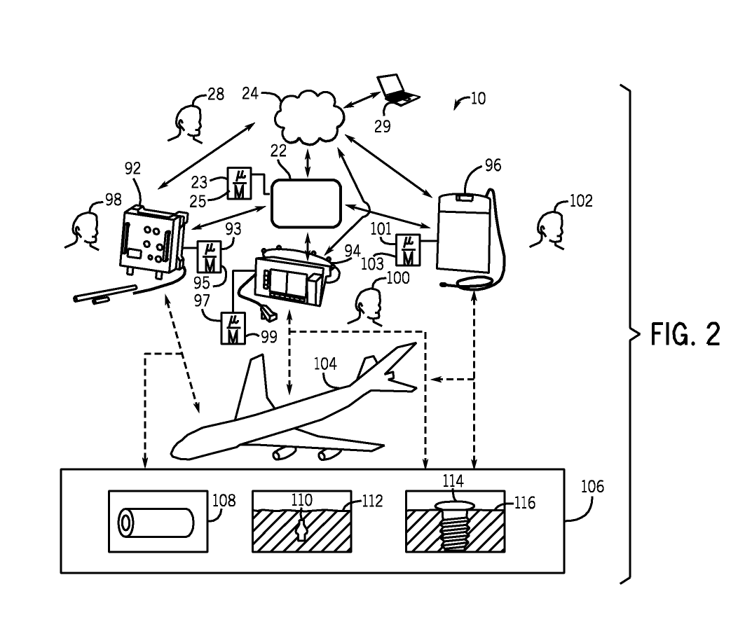

By way of introduction, and turning now to FIG. 1, the figure is a block diagram of an embodiment of distributed NDT system 10. In the depicted embodiment, the distributed NDT system 10 may include one or more NDT inspection devices 12. The NDT inspection devices 12 may be divided into at least two categories. In one category, depicted in FIG. 1, the NDT inspection devices 12 may include devices suitable for visually inspecting a variety of equipment and environments. In another category, described in more detail with respect to FIG. 2 below, the NDT devices 12 may include devices providing for alternatives to visual inspection modalities, such as x-ray inspection modalities, eddy current inspection modalities, and/or ultrasonic inspection modalities.

In the depicted first example category of FIG. 1, the NDT inspection devices 12 may include a borescope 14 having one or more processors 15 and a memory 17, and a transportable pan-tilt-zoom (PTZ) camera 16 having one or more processors 19 and a memory 21. In this first category of visual inspection devices, the bore scope 14 and PTZ camera 16 may be used to inspect, for example, a turbo machinery 18, and a facility or site 20. As illustrated, the bore scope 14 and the PTZ camera 16 may be communicatively coupled to a mobile device 22 also having one or more processors 23 and a memory 25. The mobile device 22 may include, for example, a tablet, a cell phone (e.g., smart phone), a notebook, a laptop, or any other mobile computing device. The use of a tablet, however, is apt insofar as the tablet provides for a good balance between screen size, weight, computing power, and battery life. Accordingly, in one embodiment, the mobile device 22 may be the tablet mentioned above, that provides for touchscreen input. The mobile device 22 may be communicatively coupled to the NDT inspection devices 12, such as the bore scope 14 and/or the PTZ camera 16, through a variety of wireless or wired conduits. For example, the wireless conduits may include WiFi (e.g., Institute of Electrical and Electronics Engineers [IEEE] 802.11X), cellular conduits (e.g., high speed packet access [HSPA], HSPA+, long term evolution [LTE], WiMax), near field communications (NFC), Bluetooth, personal area networks (PANs), and the like. The wireless conduits may use a variety of communication protocols, such as TCP/IP, UDP, SCTP, socket layers, and so on. In certain embodiments, the wireless or wired conduits may include secure layers, such as secure socket layers (SSL), virtual private network (VPN) layers, encrypted layers, challenge key authentication layers, token authentication layers, and so on. Wired conduits may include proprietary cabling, RJ45 cabling, co-axial cables, fiber optic cables, and so on.

Additionally or alternatively, the mobile device 22 may be communicatively coupled to the NDT inspection devices 12, such as the borescope 14 and/or the PTZ camera 16, through the “cloud” 24. Indeed, the mobile device 22 may use the cloud 24 computing and communications techniques (e.g., cloud-computing network), including but not limited to HTTP, HTTPS, TCP/IP, service oriented architecture (SOA) protocols (e.g., simple object access protocol [SOAP], web services description languages (WSDLs)) to interface with the NDT inspection devices 12 from any geographic location, including geographic locations remote from the physical location about to undergo inspection. Further, in one embodiment, the mobile device 22 may provide “hot spot” functionality in which mobile device 22 may provide wireless access point (WAP) functionality suitable for connecting the NDT inspection devices 12 to other systems in the cloud 24, or connected to the cloud 24, such as a computing system 29 (e.g., computer, laptop, virtual machine(s) [VM], desktop, workstation). Accordingly, collaboration may be enhanced by providing for multi-party workflows, data gathering, and data analysis.

For example, a borescope operator 26 may physically manipulate the borescope 14 at one location, while a mobile device operator 28 may use the mobile device 22 to interface with and physically manipulate the bore scope 14 at a second location through remote control techniques. The second location may be proximate to the first location, or geographically distant from the first location. Likewise, a camera operator 30 may physically operate the PTZ camera 16 at a third location, and the mobile device operator 28 may remote control PTZ camera 16 at a fourth location by using the mobile device 22. The fourth location may be proximate to the third location, or geographically distant from the third location. Any and all control actions performed by the operators 26 and 30 may be additionally performed by the operator 28 through the mobile device 22. Additionally, the operator 28 may communicate with the operators 26 and/or 30 by using the devices 14, 16, and 22 through techniques such as voice over IP (VOIP), virtual whiteboarding, text messages, and the like. By providing for remote collaboration techniques between the operator 28 operator 26, and operator 30, the techniques described herein may provide for enhanced workflows and increase resource efficiencies. Indeed, nondestructive testing processes may leverage the communicative coupling of the cloud 24 with the mobile device 22, the NDT inspection devices 12, and external systems coupled to the cloud 24.

In one mode of operation, the mobile device 22 may be operated by the bore scope operator 26 and/or the camera operator 30 to leverage, for example, a larger screen display, more powerful data processing, as well as a variety of interface techniques provided by the mobile device 22, as described in more detail below. Indeed, the mobile device 22 may be operated alongside or in tandem with the devices 14 and 16 by the respective operators 26 and 30. This enhanced flexibility provides for better utilization of resources, including human resources, and improved inspection results.

Whether controlled by the operator 28, 26, and/or 30, the borescope 14 and/or PTZ camera 16 may be used to visually inspect a wide variety of equipment and facilities. For example, the bore scope 14 may be inserted into a plurality of borescope ports and other locations of the turbomachinery 18, to provide for illumination and visual observations of a number of components of the turbomachinery 18. In the depicted embodiment, the turbo machinery 18 is illustrated as a gas turbine suitable for converting carbonaceous fuel into mechanical power. However, other equipment types may be inspected, including compressors, pumps, turbo expanders, wind turbines, hydroturbines, industrial equipment, and/or residential equipment. The turbomachinery 18 (e.g., gas turbine) may include a variety of components that may be inspected by the NDT inspection devices 12 described herein.

With the foregoing in mind, it may be beneficial to discuss certain turbomachinery 18 components that may be inspected by using the embodiments disclosed herein. For example, certain components of the turbomachinery 18 depicted in FIG. 1, may be inspected for corrosion, erosion, cracking, leaks, weld inspection, and so on. Mechanical systems, such as the turbomachinery 18, experience mechanical and thermal stresses during operating conditions, which may require periodic inspection of certain components. During operations of the turbomachinery 18, a fuel such as natural gas or syngas, may be routed to the turbomachinery 18 through one or more fuel nozzles 32 into a combustor 36. Air may enter the turbomachinery 18 through an air intake section 38 and may be compressed by a compressor 34. The compressor 34 may include a series of stages 40, 42, and 44 that compress the air. Each stage may include one or more sets of stationary vanes 46 and blades 48 that rotate to progressively increase the pressure to provide compressed air. The blades 48 may be attached to rotating wheels 50 connected to a shaft 52. The compressed discharge air from the compressor 34 may exit the compressor 34 through a diffuser section 56 and may be directed into the combustor 36 to mix with the fuel. For example, the fuel nozzles 32 may inject a fuel-air mixture into the combustor 36 in a suitable ratio for optimal combustion, emissions, fuel consumption, and power output. In certain embodiments, the turbomachinery 18 may include multiple combustors 36 disposed in an annular arrangement. Each combustor 36 may direct hot combustion gases into a turbine 54.

As depicted, the turbine 54 includes three separate stages 60, 62, and 64 surrounded by a casing 76. Each stage 60, 62, and 64 includes a set of blades or buckets 66 coupled to a respective rotor wheel 68, 70, and 72, which are attached to a shaft 74. As the hot combustion gases cause rotation of turbine blades 66, the shaft 74 rotates to drive the compressor 34 and any other suitable load, such as an electrical generator. Eventually, the turbomachinery 18 diffuses and exhausts the combustion gases through an exhaust section 80. Turbine components, such as the nozzles 32, intake 38, compressor 34, vanes 46, blades 48, wheels 50, shaft 52, diffuser 56, stages 60, 62, and 64, blades 66, shaft 74, casing 76, and exhaust 80, may use the disclosed embodiments, such as the NDT inspection devices 12, to inspect and maintain said components.

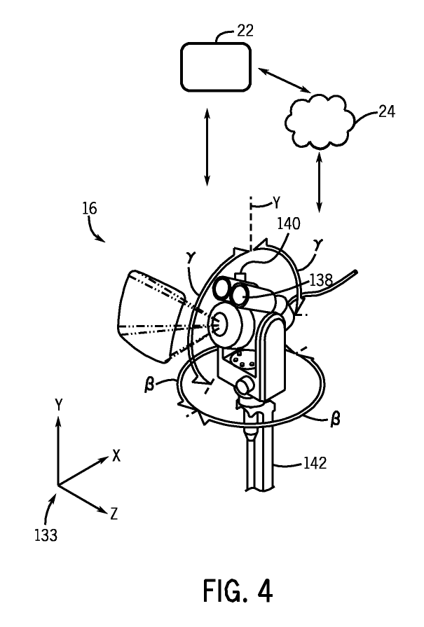

Additionally, or alternatively, the PTZ camera 16 may be disposed at various locations around or inside of the turbo machinery 18, and used to procure visual observations of these locations. The PTZ camera 16 may additionally include one or more lights suitable for illuminating desired locations, and may further include zoom, pan and tilt techniques described in more detail below with respect to FIG. 4, useful for deriving observations around in a variety of difficult to reach areas. The borescope 14 and/or the camera 16 may be additionally used to inspect the facilities 20, such as an oil and gas facility 20. Various equipment such as oil and gas equipment 84, may be inspected visually by using the borescope 14 and/or the PTZ camera 16. Advantageously, locations such as the interior of pipes or conduits 86, underwater (or underfluid) locations 88, and difficult to observe locations such as locations having curves or bends 90, may be visually inspected by using the mobile device 22 through the borescope 14 and/or PTZ camera 16. Accordingly, the mobile device operator 28 may more safely and efficiently inspect the equipment 18, 84 and locations 86, 88, and 90, and share observations in real-time or near real-time with location geographically distant from the inspection areas. It is to be understood that other NDT inspection devices 12 may be use the embodiments described herein, such as fiberscopes (e.g., articulating fiberscope, non-articulating fiberscope), and remotely operated vehicles (ROVs), including robotic pipe inspectors and robotic crawlers.

Turning now to FIG. 2, the figure is a block diagram of an embodiment of the distributed NDT system 10 depicting the second category of NDT inspection devices 12 that may be able to provide for alternative inspection data to visual inspection data. For example, the second category of NDT inspection devices 12 may include an eddy current inspection device 92, an ultrasonic inspection device, such as an ultrasonic flaw detector 94, and an x-ray inspection device, such a digital radiography device 96. The eddy current inspection device 92 may include one or more processors 93 and a memory 95. Likewise, the ultrasonic flaw detector 94 may include one or more processors 97 and a memory 104. Similarly, the digital radiography device 96 may include one or more processors 101 and a memory 103. In operations, the eddy current inspection device 92 may be operated by an eddy current operator 98, the ultrasonic flaw detector 94 may be operated by an ultrasonic device operator 100, and the digital radiography device 96 may be operated by a radiography operator 102.

As depicted, the eddy current inspection device 92, the ultrasonic flaw detector 94, and the digital radiography inspection device 96, may be communicatively coupled to the mobile device 22 by using wired or wireless conduits, including the conduits mentioned above with respect to FIG. 1. Additionally, or alternatively, the devices 92, 94, and 96 may be coupled to the mobile device 22 by using the cloud 24, for example the borescope 14 may be connected to a cellular “hotspot,” and use the hotspot to connect to one or more experts in borescopic inspection and analsysis. Accordingly, the mobile device operator 28 may remotely control various aspects of operations of the devices 92, 94, and 96 by using the mobile device 22, and may collaborate with the operators 98, 100, and 102 through voice (e.g., voice over IP [VOID]), data sharing (e.g., whiteboarding), providing data analytics, expert support and the like, as described in more detail herein.

Accordingly, it may be possible to enhance the visual observation of various equipment, such as an aircraft system 104 and facilities 106, with x-ray observation modalities, ultrasonic observation modalities, and/or eddy current observation modalities. For example, the interior and the walls of pipes 108 may be inspected for corrosion and/or erosion. Likewise, obstructions or undesired growth inside of the pipes 108 may be detected by using the devices 92, 94, and/or 96. Similarly, fissures or cracks 110 disposed inside of certain ferrous or non-ferrous material 112 may be observed. Additionally, the disposition and viability of parts 114 inserted inside of a component 116 may be verified. Indeed, by using the techniques described herein, improved inspection of equipment and components 104, 108, 112 and 116 may be provided. For example, the mobile device 22 may be used to interface with and provide remote control of the devices 14, 16, 92, 94, and 96.

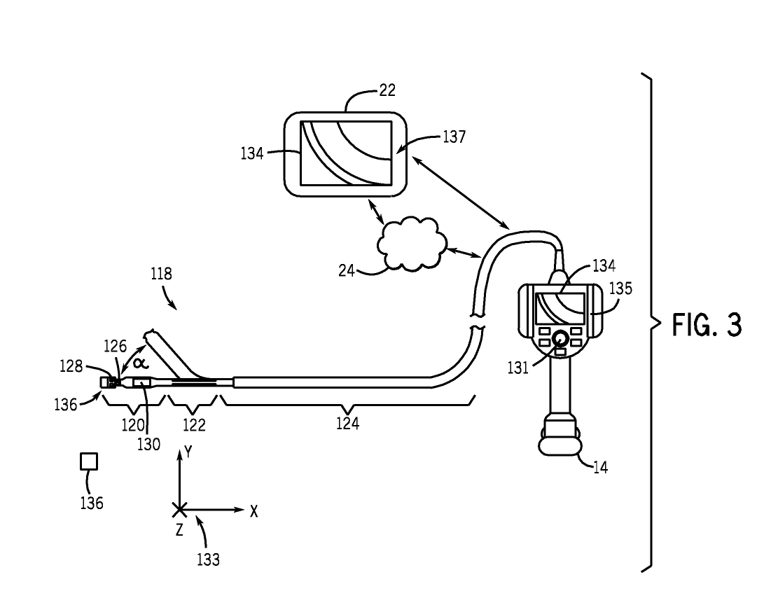

FIG. 3 is a front view of the borescope 14 coupled to the mobile device 22 and the cloud 24. Accordingly, the boresecope 14 may provide data to any number of devices connected to the cloud 24 or inside the cloud 24. As mentioned above, the mobile device 22 may be used to receive data from the borescope 14, to remote control the borescope 14, or a combination thereof. Indeed, the techniques described herein enable, for example, the communication of a variety of data from the borescope 14 to the mobile device 22, including but not limited to images, video, and sensor measurements, such as temperature, pressure, flow, clearance (e.g., measurement between a stationary component and a rotary component), and distance measurements. Likewise, the mobile device 22 may communicate control instructions, reprogramming instructions, configuration instructions, and the like, as described in more detail below.

As depicted the borescope 14, includes an insertion tube 118 suitable for insertion into a variety of location, such as inside of the turbomachinery 18, equipment 84, pipes or conduits 86, underwater locations 88, curves or bends 90, varies locations inside or outside of the aircraft system 104, the interior of pipe 108, and so on. The insertion tube 118 may include a head end section 120, an articulating section 122, and a conduit section 124. In the depicted embodiment, the head end section 120 may include a camera 126, one or more lights 128 (e.g., LEDs), and sensors 130. As mentioned above, the borescope's camera 126 may provide images and video suitable for inspection. The lights 128 may be used to provide for illumination when the head end 120 is disposed in locations having low light or no light.

During use, the articulating section 122 may be controlled, for example, by the mobile device 22 and/or a physical joy stick 131 disposed on the borescope 14. The articulating sections 122 may steer or “bend” in various dimensions. For example, the articulation section 122 may enable movement of the head end 120 in an X-Y plane X-Z plane and/or Y-Z plane of the depicted XYZ axes 133. Indeed, the physical joystick 131 and/or the mobile device 22 may both be used alone or in combination, to provide control actions suitable for disposing the head end 120 at a variety of angles, such as the depicted angle α. In this manner, the borescope head end 120 may be positioned to visually inspect desired locations. The camera 126 may then capture, for example, a video 134, which may be displayed in a screen 135 of the borescope 14 and a screen 137 of the mobile device 22, and may be recorded by the borescope 14 and/or the mobile device 22. In one embodiment, the screens 135 and 137 may be multi-touchscreens using capacitance techniques, resistive techniques, infrared grid techniques, and the like, to detect the touch of a stylus and/or one or more human fingers. Additionally or alternatively, images and the video 134 may be transmitted into the cloud 24.

Other data, including but not limited to sensor 130 data, may additionally be communicated and/or recorded by the borescope 14. The sensor 130 data may include temperature data, distance data, clearance data (e.g., distance between a rotating and a stationary component), flow data, and so on. In certain embodiments, the borescope 14 may include a plurality of replacement tips 136. For example, the replacement tips 136 may include retrieval tips such as snares, magnetic tips, gripper tips, and the like. The replacement tips 136 may additionally include cleaning and obstruction removal tools, such as wire brushes, wire cutters, and the like. The tips 136 may additionally include tips having differing optical characteristics, such as focal length, stereoscopic views, 3-dimensional (3D) phase views, shadow views, and so on. Additionally or alternatively, the head end 120 may include a removable and replaceable head end 120. Accordingly, a plurality of head ends 120 may be provided at a variety of diameters, and the insertion tube 118 maybe disposed in a number of locations having openings from approximately one millimeter to ten millimeters or more. Indeed, a wide variety of equipment and facilities may be inspected, and the data may be shared through the mobile device 22 and/or the cloud 24.

FIG. 4 is a perspective view of an embodiment of the transportable PTZ camera 16 communicatively coupled to the mobile device 22 and to the cloud 24. As mentioned above, the mobile device 22 and/or the cloud 24 may remotely manipulate the PTZ camera 16 to position the PTZ camera 16 to view desired equipment and locations. In the depicted example, the PTZ camera 16 may be tilted and rotated about the Y-axis. For example, the PTZ camera 16 may be rotated at an angle 13 between approximately 0° to 180°, 0° to 270°, 0° to 360°, or more about the Y-axis. Likewise, the PTZ camera 16 may be tilted, for example, about the Y-X plane at an angle γ of approximately 0° to 100°, 0° to 120°, 0° to 150°, or more with respect to the Y-Axis. Lights 138 may be similarly controlled, for example, to active or deactivate, and to increase or decrease a level of illumination (e.g., lux) to a desired value. Sensors 140, such as a laser rangefinder, may also be mounted onto the PTZ camera 16, suitable for measuring distance to certain objects. Other sensors 140 may be used, including long-range temperature sensors (e.g., infrared temperature sensors), pressure sensors, flow sensors, clearance sensors, and so on.

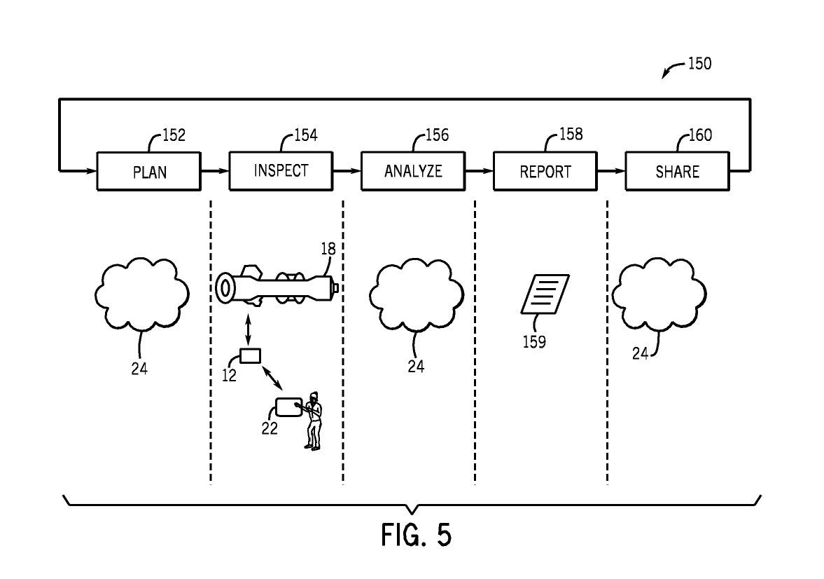

The PTZ camera 16 may be transported to a desired location, for example, by using a shaft 142. The shaft 142 enables the camera operator 30 to move the camera and to position the camera, for example, inside of locations 86, 108, underwater 88, into hazardous (e.g., hazmat) locations, and so on. Additionally, the shaft 142 may be used to more permanently secure the PTZ camera 16 by mounting the shaft 142 onto a permanent or semi-permanent mount. In this manner, the PTZ camera 16 may be transported and/or secured at a desired location. The PTZ camera 16 may then transmit, for example by using wireless techniques, image data, video data, sensor 140 data, and the like, to the mobile device 22 and/or cloud 24. Accordingly, data received from the PTZ camera 16 may be remotely analyzed and used to determine the condition and suitability of operations for desired equipment and facilities. Indeed, the techniques described herein may provide for a comprehensive inspection and maintenance process suitable for planning, inspecting, analyzing, and/or sharing a variety of data by using the aforementioned devices 12, 14, 16, 22, 92, 94, 96, and the cloud 24, as described in more detail below with respect to FIG. 5.

FIG. 5 is a flowchart of an embodiment of a process 150 suitable for planning, inspecting, analyzing, and/or sharing a variety of data by using the aforementioned devices 12, 14, 16, 22, 92, 94, 96, and the cloud 24. Indeed, the techniques described herein may use the devices 12, 14, 16, 22, 92, 94, 96 to enable processes, such as the depicted process 150, to more efficiently support and maintain a variety of equipment. In certain embodiments, the process 150 or portions of the process 150 may be included in non-transitory computer-readable media stored in memory, such as the memory 15, 19, 23, 93, 97, 101 and executable by one or more processors, such as the processors 17, 21, 25, 95, 99, 103.

In one example, the process 150 may plan (block 152) for inspection and maintenance activities. Data acquired by using the devices 12, 14, 16, 22, 42, 44, 46, an others, such as fleet data acquired from a fleet of turbomachinery 18, from equipment users (e.g., aircraft 104 service companies), and/or equipment manufacturers, may be used to plan (block 152) maintenance and inspection activities, more efficient inspection schedules for machinery, flag certain areas for a more detailed inspection, and so on. The process 150 may then enable the use of a single mode or a multi-modal inspection (block 154) of desired facilities and equipment (e.g., turbomachinery 18). As mentioned above, the inspection (block 154) may use any one or more of the NDT inspection devices 12 (e.g., borescope 14, PTZ camera 16, eddy current inspection device 92, ultrasonic flaw detector 94, digital radiography device 96), thus providing with one or more modes of inspection (e.g., visual, ultrasonic, eddy current, x-ray). In the depicted embodiment, the mobile device 22 may be used to remote control the NDT inspection devices 12, to analyze data communicated by the NDT inspection devices 12, to provide for additional functionality not included in the NDT inspection devices 12 as described in more detail herein, to record data from the NDT inspection devices 12, and to guide the inspection (block 154), for example, by using menu-driven inspection (MDI) techniques, among others.

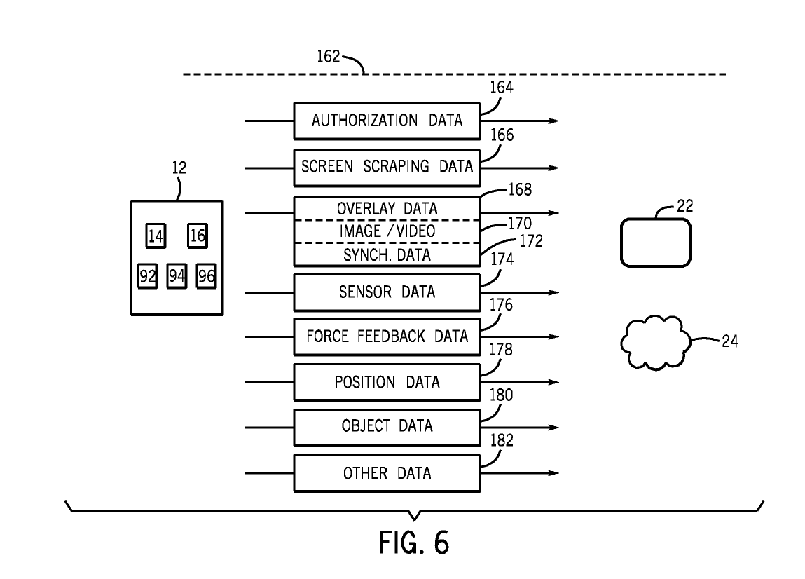

Results of the inspection (block 154), may then be analyzed (block 156), for example, by using the NDT device 12, by transmitting inspection data to the cloud 24, by using the mobile device 22, or a combination thereof. The analysis may include engineering analysis useful in determining remaining life for the facilities and/or equipment, wear and tear, corrosion, erosion, and so forth. The analysis may additionally include operations research (OR) analysis used to provide for more efficient parts replacement schedules, maintenance schedules, equipment utilization schedules, personnel usage schedules, new inspection schedules, and so on. The analysis (block 156) may then be reported (block 158), resulting in one or more reports 159, including reports created in or by using the cloud 24, detailing the inspection and analysis performed and results obtained. The reports 159 may then be shared (block 160), for example, by using the cloud 24, the mobile device 22, and other techniques, such as workflow sharing techniques. In one embodiment, the process 150 may be iterative, thus, the process 150 may iterate back to planning (block 152) after the sharing (block 160) of the reports 159. By providing for embodiments useful in using the devices (e.g., 12, 14, 16, 22, 92, 94, 96) described herein to plan, inspect, analyze, report, and share data, the techniques described herein may enable a more efficient inspection and maintenance of the facilities 20, 106 and the equipment 18, 104. Indeed, the transfer of multiple categories of data may be provided, as described in more detail below with respect to FIG. 6.

FIG. 6 is a data flow diagram depicting an embodiment of the flow of various data categories originating from the NDT inspection devices 12 (e.g., devices 14, 16, 92, 94, 96) and transmitted to the mobile device 22 and/or the cloud 24. As mentioned above, the NDT inspection devices 12 may use a wireless conduit 162 to transmit the data. In one embodiment, the wireless conduit 112 may include WiFi (e.g., 802.11X), cellular conduits (e.g., HSPA, HSPA+, LTE, WiMax), NFC, Bluetooth, PANs, and the like. The wireless conduit 162 may use a variety of communication protocols, such as TCP/IP, UDP, SCTP, socket layers, and so on. In certain embodiments, the wireless conduit 162 may include secure layers, such as SSL, VPN layers, encrypted layers, challenge key authentication layers, token authentication layers, and so on. Accordingly, an authorization data 164 may be used to provide any number of authorization or login information suitable to pair or otherwise authenticate the NDT inspection device 12 to the mobile device 22 and/or the cloud 24. Additionally, the wireless conduit 162 may dynamically compress data, depending on, for example, currently available bandwidth and latency. The mobile device 22 may then uncompress and display the data. Compression/decompression techniques may include H.261, H.263, H.264, moving picture experts group (MPEG), MPEG-1, MPEG-2, MPEG-3, MPEG-4, DivX, and so on.

In certain modalities (e.g., visual modalities), images and video may be communicated by using certain of the NDT inspection devices 12. Other modalities may also send video, sensor data, and so on, related to or included in their respective screens. The NDT inspection device 12 may, in addition to capturing images, overlay certain data onto the image, resulting in a more informative view. For example, a borescope tip map may be overlaid on the video, showing an approximation of the disposition of a borescope tip during insertion so as to guide the operator 26 to more accurately position the borescope camera 126. The overlay tip map may include a grid having four quadrants, and the tip 136 disposition may be displayed as dot in any portion or position inside of the four quadrants. A variety of overlays may be provided, as described in more detail below, including measurement overlays, menu overlays, annotation overlays, and object identification overlays. The image and video data, such as the video 84, may then be displayed, with the overlays generally displayed on top of the image and video data.

In one embodiment, the overlays, image, and video data may be “screen scraped” from the screen 135 and communicated as screen scrapping data 166. The screen scrapping data 166 may then be displayed on the mobile device 22 and other display devices communicatively coupled to the cloud 24. Advantageously, the screen scrapping data 166 may be more easily displayed. Indeed, because pixels may include both the image or video and overlays in the same frame, the mobile device 22 may simply display the aforementioned pixels. However, providing the screen scraping data may merge both the images with the overlays, and it may be beneficial to separate the two (or more) data streams. For example, the separate data streams (e.g., image or video stream, overlay stream) may be transmitted approximately simultaneously, thus providing for faster data communications. Additionally, the data streams may be analyzed separately, thus improving data inspection and analysis.

Accordingly, in one embodiment, the image data and overlays may be separated into two or more data streams 168 and 170. The data stream 168 may include only overlays, while the data stream 170 may include images or video. In one embodiment, the images or video 170 may be synchronized with the overlays 168 by using a synchronization signal 172. For example, the synchronization signal may include timing data suitable to match a frame of the data stream 170 with one or more data items included in the overlay stream 168. In yet another embodiment, no synchronization data 172 data may be used. Instead, each frame or image 170 may include a unique ID, and this unique ID may be matched to one or more of the overlay data 168 and used to display the overlay data 168 and the image data 170 together.

The overlay data 168 may include a tip map overlay. For example, a grid having four squares (e.g., quadrant grid) may be displayed, along with a dot or circle representing a tip 136 position. This tip map may thus represent how the tip 136 is being inserted inside of an object. A first quadrant (top right) may represent the tip 136 being inserted into a top right corner looking down axially into the object, a second quadrant (top left) may represent the tip 136 being inserted into a left right corner looking down axially, a third quadrant (bottom left) may represent the tip 136 being inserted into a bottom left corner, and a fourth quadrant (bottom right) may represent the tip 136 being inserted into a bottom right corner. Accordingly, the borescope operator 26 may more easily guide insertion of the tip 136.

The overlay data 168 may also include measurement overlays. For example, measurement such as length, point to line, depth, area, multi-segment line, distance, skew, and circle gauge may be provided by enabling the user to overlay one or more cursor crosses (e.g., “+”) on top of an image. In one embodiment a stereo probe measurement tip 136, or a shadow probe measurement tip 136 may be provided, suitable for measurements inside of objects, including stereoscopic measurements and/or by projecting a shadow onto an object. By placing a plurality of cursor icons (e.g., cursor crosses) over an image, the measurements may be derived using stereoscopic techniques. For example, placing two cursors icons may provide for a linear point-to-point measurement (e.g., length). Placing three cursor icons may provide for a perpendicular distance from a point to a line (e.g., point to line). Placing four cursor icons may provide for a perpendicular distance between a surface (derived by using three cursors) and a point (the fourth cursor) above or below the surface (e.g., depth). Placing three or more cursors around a feature or defect may then give an approximate area of the surface contained inside the cursors. Placing three or more cursors may also enable a length of a multi-segment line following each cursor.

Likewise, by projecting a shadow, the measurements may be derived based on illumination and resulting shadows. Accordingly, by positioning the shadow across the measurement area, then placing two cursors as close as possible to the shadow at furthermost points of a desired measurement may result in the derivation of the distance between the points. Placing the shadow across the measurement area, and then placing cursors at edges (e.g., illuminated edges) of the desired measurement area approximately to the center of a horizontal shadow may result in a skew measurement, otherwise defined as a linear (point-to-point) measurement on a surface that is not perpendicular to the probe 14 view. This may be useful when a vertical shadow is not obtainable.

Similarly, positioning a shadow across the measurement area, and then placing one cursor on a raised surface and a second cursor on a recessed surface may result in the derivation of depth, or a distance between a surface and a point above or below the surface. Positioning the shadow near the measurement area, and then placing a circle (e.g., circle cursor of user selectable diameter, also referred to as circle gauge) close to the shadow and over a defect may then derive the approximate diameter, circumference, and/or area of the defect.

Overlay data 168 may also include annotation data. For example, text and graphics (e.g. arrow pointers, crosses, geometric shapes) may be overlaid on top of an image to annotate certain features, such as “surface crack.” Additionally, audio may be captured by the NDT inspection device 12, and provided as an audio overlay. For example, a voice annotation, sounds of the equipment undergoing inspection, and so on, may be overlaid on an image or video as audio. The overlay data 168 received by the mobile device 22 and/or cloud 24 may then be rendered by a variety of techniques. For example, HTML5 or other markup languages may be used to display the overlay data 168. In one embodiment, the mobile device 22 and/or cloud 24 may provide for a first user interface different from a second user interface provided by the NDT device 12. Accordingly, the overlay data 168 may be simplified and only send basic information. For example, in the case of the tip map, the overlay data 168 may simply include X and Y data correlative to the location of the tip, and the first user interface may then use the X and Y data to visually display the tip on a grid.

Additionally sensor data 174 may be communicated. For example, data from the sensors 126, 140, and x-ray sensor data, eddy current sensor data, and the like may be communicated. In certain embodiments, the sensor data 174 may be synchronized with the overlay data 168, for example, overlay tip maps may be displayed alongside with temperature information, pressure information, flow information, clearance, and so on. Likewise, the sensor data 174 may be displayed alongside the image or video data 170.

In certain embodiments, force feedback or haptic feedback data 176 may be communicated. The force feedback data 176 may include, for example, data related to the borescope 14 tip 136 abutting or contacting against a structure, vibrations felt by the tip 136 or vibration sensors 126, force related to flows, temperatures, clearances, pressures, and the like. The mobile device 22 may include, for example, a tactile layer having fluid-filled microchannels, which, based on the force feedback data 176, may alter fluid pressure and/or redirect fluid in response. Indeed, the techniques describe herein, may provide for responses actuated by the mobile device 22 suitable for representing sensor data 174 and other data in the conduit 162 as tactile forces.

The NDT devices 12 may additionally communicate position data 178. For example, the position data 178 may include locations of the NDT devices 12 in relation to equipment 18, 104, and/or facilities 20, 106. For example, techniques such as indoor GPS, RFID, triangulation (e.g., WiFi triangulation, radio triangulation) may be used to determine the position 178 of the devices 12. Object data 180 may include data related to the object under inspection. For example, the object data 180 may include identifying information (e.g., serial numbers), observations on equipment condition, annotations (textual annotations, voice annotations), and so on. Other types of data 182 may be used, including but not limited to menu-driven inspection data, which when used, provides a set of pre-defined “tags” that can be applied as text annotations and metadata. These tags may include location information (e.g., 1^{st} stage HP compressor) or indications (e.g., foreign object damage) related to the object undergoing inspection. Other data 182 may additionally include remote file system data, in which the mobile device 22 may view and manipulate files and file constructs (e.g., folders, subfolders) of data located in the memory 25 of the NDT inspection device 12. Accordingly, files may be transferred to the mobile device 22 and cloud 24, edited and transferred back into the memory 25. By communicating the data 164-182 to the mobile device 22 and the cloud 24, the techniques described herein may enable a faster and more efficient process 150.

### Step-Based Reference Material Provision

As previously discussed, it may be beneficial to provide supplemental data based upon progress of an inspection. The supplemental data may aid in conducting a proper inspection. For example, in some embodiments, the supplemental data may include reference information provided by a manufacturer of the inspection equipment used in the inspection (e.g., a borescope, ultrasound, etc.). Further, reference information may be provided from a manufacturer of the object being inspected (e.g., a turbine or airplane). In some embodiments, historical inspection data or data relating to previous inspections may be provided as supplemental data.

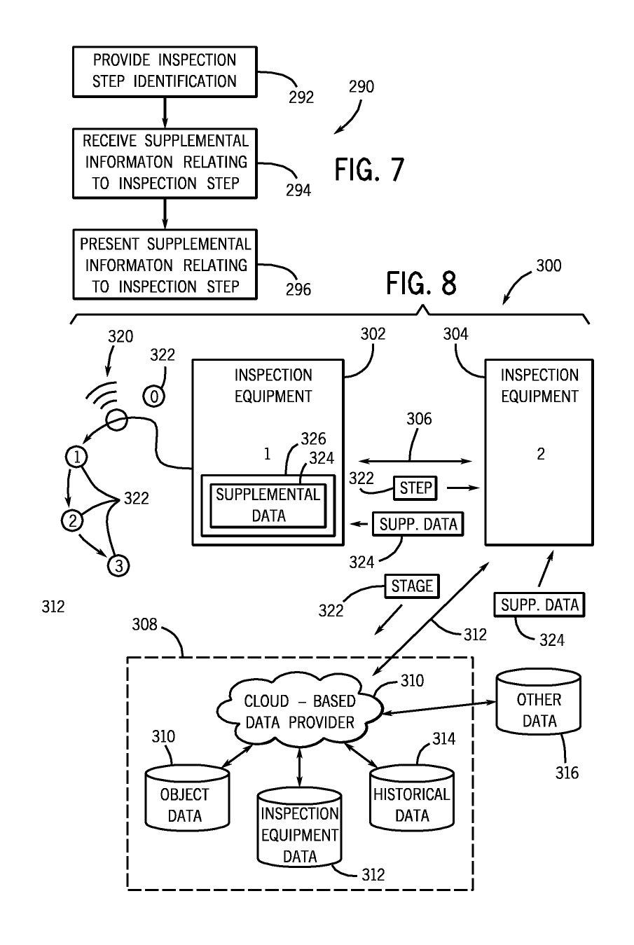

FIG. 7 is a flowchart illustrating a process 290 for providing reference information during an inspection, in accordance with an embodiment. The process 290 begins by obtaining and providing inspection step identification to a data service provider (block 292). For example, a piece of inspection equipment may determine a particular step of an inspection that is currently being performed. As used herein, the term inspection equipment may include inspection tools, meaning devices used to observe an/or collect inspection data during the inspection process, including the NDT devices 12, such as a PTZ camera, an X-ray device, an eddy current device, etc. Further the term inspection equipment may include computers or other data processers that execute machine-readable instructions relating to inspection-related tasks, such as: providing relevant supplemental data to an inspector and/or recording and/or storing data obtained from inspection tools, etc. While the supplemental data may include inspection-related data, the supplemental data is not limited to such data. The supplemental data may include any data that is relevant to an inspection. For example, an input oil pressure and/or temperature may be useful in determining the origin of a crack found during an aircraft inspection, thus, because this information is relevant to the inspection, it may be included in the supplemental data.

An inspection may involve a number of steps. Prior to the inspection, there may be an introductory step (e.g., step 0) that identifies details of the inspection such as the object that is to be inspected, any particular portion of the object that is to be inspected, the type of inspection, the equipment to be used during the inspection, any required or useful probes, required or useful training and/or certifications of the inspector, etc. Prior to, during, or upon completion of a particular step (e.g., the first actual step of the inspection), supplemental data may be useful. For example, instructional aides may provide an explanation of proper techniques for obtaining data using an inspection tool.

The current step of the inspection may be determined via a user entry in the inspection equipment and/or may be automatically obtained based upon logic provided in the inspection equipment and/or data provided to the inspection equipment. For example, the inspection equipment may include menu-driven inspection (MDI), which provides step-by-step instructions for inspection, annotation, and so on. As steps are completed during the MDI process, the inspection equipment may determine the next step in the inspection process. In alternative embodiments, the inspection steps may be determined based upon a user input, based upon a position and/or location of the inspection equipment, a time-based inspection schedule, or any other manner that identifies the inspection step.

Once the inspection step is determined, supplemental data relevant to the inspection step may be obtained (block 294). For example, the supplemental data may include data relating to the object that is being inspected, relating to the inspection equipment, and/or historical inspection data. Further, the supplemental data may include pre-processed data provided from any source, either remote or local to the inspection environment. This supplemental data may be used, for example, to educate an inspector that is completing inspection steps, provide additional analysis of data captured during an inspection step, provide alerts, etc. In some embodiments, data repositories containing supplemental data may be polled based upon an identifier of the determined current step. Further, in certain embodiments, sensors, such as temperature sensors, pressure sensors, motion sensors, etc. may provide supplemental data relevant to an inspection, and thus may be included in the supplemental data.

Once the supplemental data is obtained, the data may be presented (block 296). In some embodiments, the supplemental data may be provided via any number human machine interfaces. For example, images and/or text associated with the supplemental data may be displayed via an electronic display. Audio may be audibly presented via speakers. Further, video data may be played back through a display and/or speakers. Further, haptic technology may provide touch sensations representative of the supplemental data.

In some embodiments, the data may be presented to one or more processors for further processing. For example, in one embodiment, supplemental data may include historical images gathered during prior inspections. These historical images may be presented to a processor that runs an algorithm that measures crack progression from the historical images to the currently collected inspection data. This algorithm might, for example, determine a remaining useful life of the asset. Accordingly, as may be appreciated, presenting the supplemental data, either for consumption by an operator and/or further processing, may enable more accurate inspections and/or provide a more detailed understanding of an inspection by providing step-specific supplemental data that may aid in accurately completing inspection steps and/or analyzing data obtained during these inspection steps.

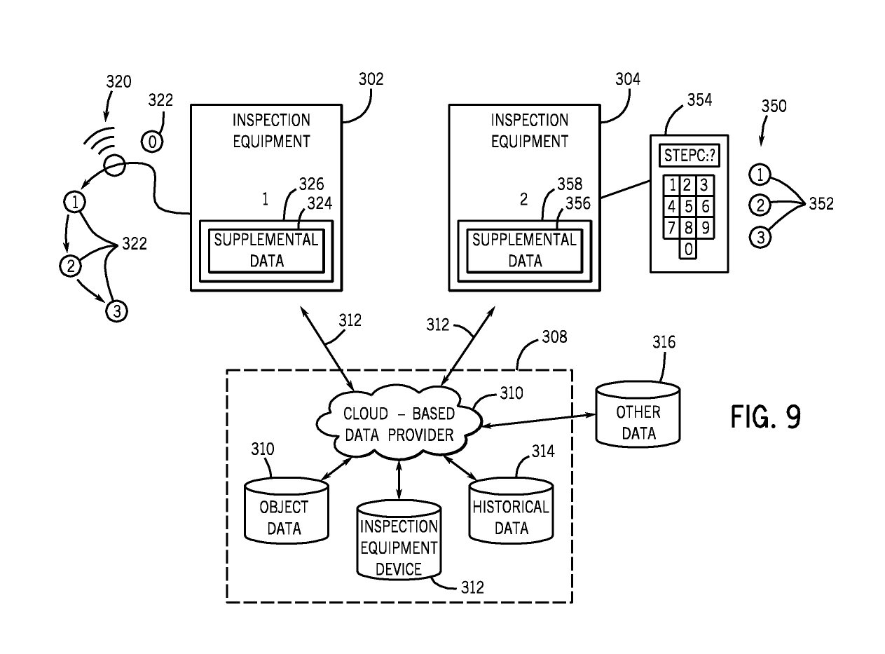

FIG. 8 is a schematic diagram of an inspection system 300 that provides step-specific supplemental data, in accordance with an embodiment. As illustrated, one or more pieces of inspection equipment (e.g., “Inspection Equipment 1” 302 and “Inspection Equipment 2” 304) may be communicatively coupled, as illustrated by the communication connection arrow 306. For example, the inspection equipment may be connected via a wired or wireless communication network, such as an Ethernet network, Bluetooth network, or WIFI network.

One or more of the pieces of inspection equipment may be communicatively coupled to data provider services 308 that are enabled to provide pertinent data relevant to an inspection step to the connected inspection equipment. For instance, in the current example, “Inspection Equipment 2” 302, which may be a computer, for example, is communicatively coupled to a cloud-based data provider 310, as illustrated by the data connection arrow 312.

The data provider services 308 may include repositories for inspection-relevant data (e.g., object data 310, relating to an object being inspected; inspection equipment data, relating to the inspection equipment (e.g., “Inspection Equipment 1” 302 or “Inspection Equipment 2” 304); and/or historical inspection data 314, relating to previous data collect during inspections. Further, the data provider services 308 may retrieve data relevant to an inspection from external data repositories (e.g., data repository 316), which may provide, for example, training information, reference information, etc.

As mentioned above, an inspection of an object may be quite complex, having a number of steps. For example, the inspection process 320 has multiple steps 322 (as indicated by steps 0, 1, 2, and 3). Steps 1-3 may be provided by a digitized application that is executable on one or more pieces of inspection equipment. Step 0 of the inspection process 320 may represent identifying the current inspection (e.g., the type of inspection, the object that is to be inspected, etc.). It may be beneficial to provide supplemental inspection data based upon a current step of an inspection process. To do this, the inspection equipment may discern a current inspection step that has been or is currently being implemented. The inspection instrument may provide an identifier for the discerned step 322 to the data provider services 308, where supplemental data 324 relevant to the identifier 322 may be obtained and provided to the inspection equipment. The inspection equipment may then format and present at least a portion of the supplemental data 322 on a presentation device (e.g., a display 326) of the inspection equipment, thus providing the inspector or other operator with relevant information pertaining to a particular step of the inspection process 320.

For example, in the embodiment pictured in FIG. 8, “Inspection Equipment 1” 302 may discern that an inspection is about to take place. Accordingly, the inspection information may be identified and an identifier for step 0 may be provided to the data provider services 308, here cloud-based services 310. While the current example uses step 0 to illustrate an introductory step where introductory information may be provided, other embodiments of providing introductory information may include providing such introductory information without specifying a particular introductory step, such as step 0. For example, in some embodiments, a piece of inspection equipment may provide the introductory information based upon the initialization of an inspection application or plan.

Because “Inspection Equipment 1” 302 does not have direct communication coupling to the data provider services in the current example, “Inspection Equipment 1” 302 may provide the identifier 322 to “Inspection Equipment 2” 304, which does have a direct communication coupling to the data provider services 308. “Inspection Equipment 2” 304 may relay the identifier 322 to the data provider services 308, where the services 308 may gather relevant supplemental data relevant to the current step identifier 322.

The relevant supplemental data may vary depending on a particular step of the process 320. For example, as mentioned above, step 0 may relate to the overall inspection. Accordingly, supplemental data 324 relevant to the overall inspection and/or the overall object to be inspected may be provided. However, prior to, during, and/or post completing a particular step (e.g., step 1, 2, or 3) of the inspection process 320, different supplemental data may be useful. For example, the supplemental data 324 for a particular step 322 may provide audio, video, haptic feedback, and/or textual based instructions regarding proper technique useful for completing the particular step 322. Additionally, the supplemental data 324 may include data relevant to the particular step 322 and data obtained while implementing the particular step 322.

Once the supplemental data 324 is gathered, the data provider services 308 may provide the supplemental data 324 to the inspection equipment requesting the supplemental data 324 (e.g., “Inspection Equipment 1” 302 via “Inspection Equipment 2” 304 in the current example). Thus, the inspection equipment may present the supplemental data 324 via a presentation device (e.g., display 326 of “Inspection Equipment 1” 302 in the current example).

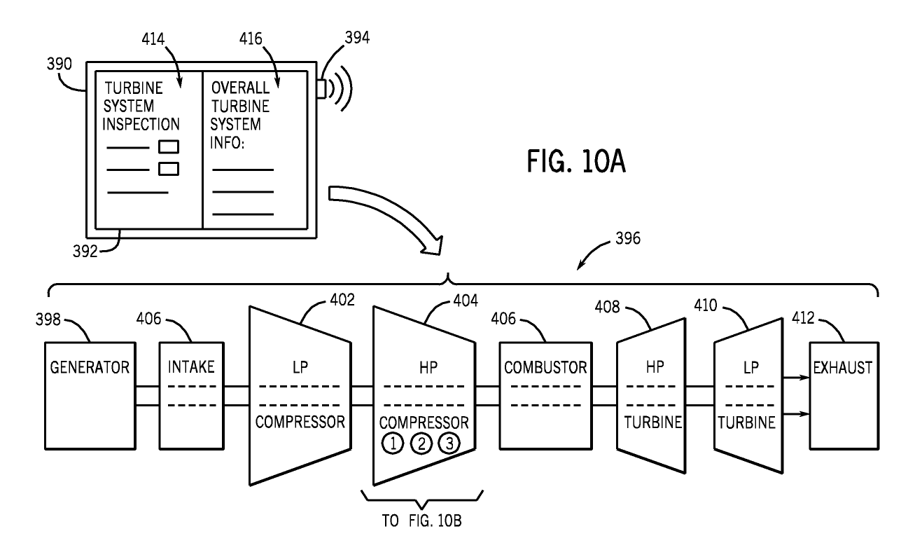

FIG. 9 is a schematic diagram of an alternate inspection system useful for providing step-specific supplemental data during an inspection, in accordance with an embodiment. In the current embodiment, both “Inspection Equipment 1” 302 and “Inspection Equipment 2” 304 are directly communicatively coupled to the data provider service 308, as illustrated by arrows 312. Accordingly, “Inspection Equipment 1” 302 does not submit supplemental data requests through “Inspection Equipment 2” 304, but instead submits the request directly to the data provider service 308. As previously discussed, the inspection process may include many steps 322 and supplemental data 324 relevant to the inspection steps 322 may be presented via a presentation device (e.g., display 326). As discussed above, the supplemental data may include, for example: object data 310, relating to the object being inspected; inspection equipment data 312, relating to the inspection equipment; historical data 314, relating to previous inspections; or any other data 316.

In the current example “Inspection Equipment 2” 304 is used to complete an inspection 350 with inspection steps 352. A user input device 354 (e.g., a keypad, touchpad, microphone, etc.) may be used to enable an operator to specify a particular current step 352. An identifier of the current step 352 may be provided to the data provider service 308 (e.g., cloud-based data provider 310) where supplemental data 356 is gathered. The supplemental data 356 is provided to “Inspection Equipment 2” 304 and is presented on display 358.

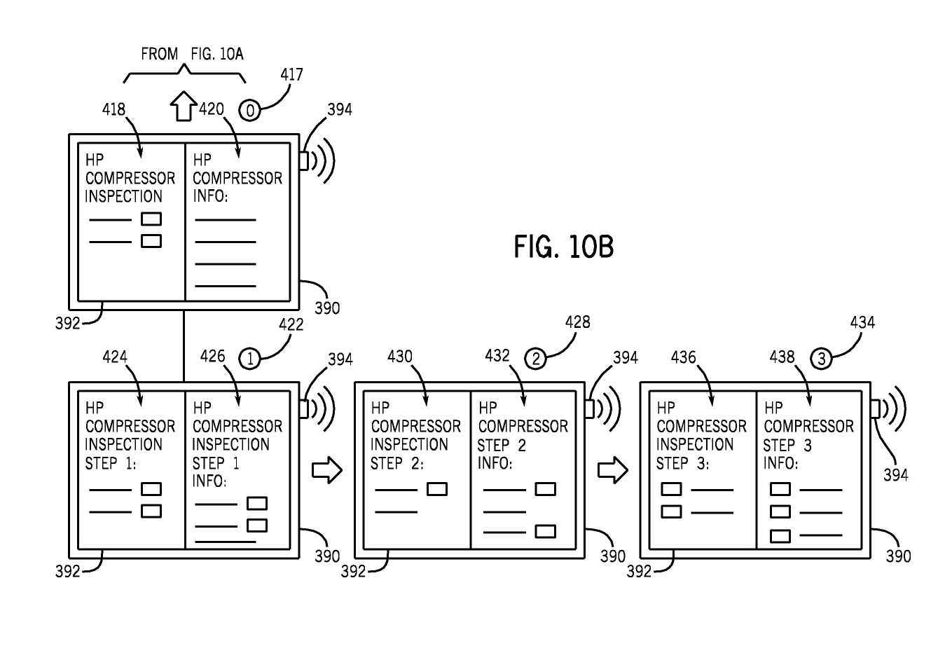

FIG. 10A and FIG. 10B collectively illustrate a schematic view illustrating the presentation of step-specific supplemental data, in accordance with an embodiment. The inspection equipment 390 is equipped with a display 392 and/or one or more speakers 394. The inspection equipment may be utilized to inspect an object with many components. For instance, in the current example, the inspection equipment is being used in the inspection of a turbine 396 that includes a generator 398, an intake 400, a low pressure compressor 402, a high pressure compressor 404, a combustor 406, a high pressure turbine 408, a low pressure turbine 410, and an exhaust system 412. The inspection equipment may determine that an inspection of the turbine system 396 is planned, and provide over view instructions 414 for the overall turbine system inspection. Further, the inspection equipment 390 may obtain supplemental data 416 for the overall turbine system (e.g., according to process 290 of FIG. 7) based upon determining the object that is to be inspected (e.g., the turbine system 396). The supplemental data 416 may be presented via the display 392 and/or the speaker 394. For example, in the current embodiment, a split-screen provides the overview instructions 414 and the supplemental data 416 for the overall turbine system 396 in the same view.

A particular component of the object may be inspected. For instance, in the current example, the inspection equipment 390 is being used to inspect the high pressure compressor 404. Upon detecting inspection of the high pressure compressor (as indicated by the step 0 reference 417), overview instructions 418 and/or supplemental data 420 relevant to the overview of the high pressure compressor 404 inspection may be provided (e.g., via the display 392 and/or the speaker(s) 394). Upon detecting step 1 (as indicated by the step 1 reference 422), Step 1 instructions 424 and/or supplemental data 426 relevant to Step 1 of the high pressure compressor 404 inspection may be provided (e.g., via the display 392 and/or the speaker(s) 394). Further, upon detecting step 2 (as indicated by the step 2 reference 428), Step 2 instructions 430 and/or supplemental data 432 relevant to Step 2 of may be provided. Additionally, upon detecting step 3 (as indicated by the step 3 reference 434), Step 3 instructions 436 and/or supplemental data 438 relevant to Step 3 may be provided, and so forth.

As may be appreciated, by utilizing step-based supplemental data, inspections may become more efficient and accurate. The step-based supplemental data may provide particular information of interest for an inspection step, may provide information relating to the object being inspected, historical inspection data, and/or information relating to the inspection equipment. Thus, an operator of the inspection equipment may be more informed and able to more accurately and cost-effectively complete an inspection.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method, comprising:
providing, via a computer processor, identification information configured to identify a particular step or portion of an inspection process;
receiving supplemental data relating to the particular step or portion based at least in part upon the identification information; and
presenting the supplemental data.

2. The method of claim 1, comprising providing the identification information to a data provider service in the form of a data query.

3. The method of claim 1, wherein providing the identification information comprises: determining a current step of the inspection process and providing the identification information related to the current step.

4. The method of claim 1, comprising:
providing identification information that identifies an overview of the inspection process; and
receiving supplemental data relating to the overview of the inspection process.

5. The method of claim 4, wherein receiving the supplemental data comprises receiving introductory information relating to the inspection process.

6. The method of claim 1, wherein receiving the supplemental data comprises:
receiving data relating to: an object to be inspected during the inspection process, a particular piece of equipment involved in the inspection process, historical inspection data relating to the inspection process, or any combination thereof.

7. The method of claim 1, comprising presenting instructions for the particular step or portion alongside the supplemental data relating to the particular step or portion.

8. An inspection equipment, comprising:
step determination logic, configured to determine a particular step or portion of an inspection process that the inspection equipment is being used to execute;
communications circuitry, configured to query a data provider for supplemental data relating at least to the particular step or portion and receive the supplemental data from the data provider; and
at least one human machine interface configured to present the supplemental data, information relating to the supplemental data, or both.

9. The inspection equipment of claim 8, wherein the step determination logic comprises:
an input device configured to receiving an input specifying the particular step or portion of the inspection plan; and
logic to interpret the input.

10. The inspection equipment of claim 9, wherein the input device comprises a keypad, a touch screen, hardware-based input structures, software-based input structures, a microphone, or any combination thereof.

11. The inspection equipment of claim 8, wherein the communications circuitry is configured to:
query the data provider directly; or
query the data provider via a device external to the inspection device that is communicatively coupled to the data provider; or both.

12. The inspection equipment of claim 8, wherein the supplemental data comprises audio, video, images, or any combination thereof presentable to the human machine interface, a processor for subsequent processing, or both.

13. A system, comprising:
a data provider configured to:
receive a request for supplemental data relating to a particular step or portion of an inspection process;
gather the supplemental data from one or more data sources; and
provide the gathered supplemental data to a requestor of the supplemental data.

14. The system of claim 13, wherein the one or more data sources comprise at least one data repository containing data relating to: an object inspected during the inspection process, an inspection device used during the inspection process; or historical data relating to the inspection process; or any combination thereof.

15. The system of claim 14, wherein the data provider is configured to provide the gathered supplemental data to the requestor via a pass-through from a device separate from the requestor that is communicatively coupled to the requestor and the data provider.

16. The system of claim 14, where the data provider is a cloud-based data provider.

17. The system of claim 13, comprising a piece of inspection equipment, configured to:
request the supplemental data from the data provider;
receive the gathered supplemental data from the data provider; and
present the gathered supplemental data.

18. The system of claim 17, comprising a second piece of inspection equipment, wherein the second piece of inspection equipment is configured to act as a pass-through for providing the supplemental data to the piece of inspection equipment when the piece of inspection equipment is not directly communicatively coupled to the data provider.

19. The system of claim 17, wherein the piece of inspection equipment is configured to present the gathered supplemental data to a processor for processing.

20. The system of claim 13, wherein the particular step or portion comprises: an overall portion representative of an object inspected though the inspection process, a component portion representative of a component of the object, a particular step regarding inspection of the component, or a conclusion portion representative of the end of the inspection process.
